(19) United States
(12) Patent Application Publication
(10) Pub. No.: US 2026/0254626 A1
(43) Pub. Date: Aug. 27, 2026

(54) HARDWARE-ENTANGLED KEY GENERATION

(71) Applicant: TELEFONAKTIEBOLAGET LM ERICSSON (PUBL), STOCKHOLM (SE)

(72) Inventors: Niklas Lindskog, Lund (SE); Håkan Englund, Lund (SE)

(21) Appl. No.: 18/994,249

(22) PCT Filed: Jul. 15, 2022
(86) PCT No.: PCT/IB2022/056554

§ 371 Date: Jan. 14, 2025

(51) Int. Cl. H04L 9/08; G06F 21/57

(52) U.S. Cl. CPC H04L 9/0866; G06F 21/575; H04L 9/0877

(57) ABSTRACT

Systems and methods for an extended boot key derivation framework are disclosed herein. In some embodiments, a method performed by a master hardware module comprises generating a Unique Module Secret (UMS) of the master hardware module, deriving a secret of the master hardware module based on the UMS of the master hardware module and a Security Descriptor (SD) of the master hardware module using a first Key Derivation Function (KDF) of the master hardware module, generating an asymmetric key pair of the master hardware module based on the secret of the master hardware module using a function, receiving a UMS of the first subsequent hardware module and a first SD of the first subsequent hardware module from the first subsequent hardware module.

### TECHNICAL FIELD

The present disclosure is directed to systems and methods on an extended boot key derivation framework where a hardware module and firmware unique keys are generated.

### BACKGROUND

### Physically Unclonable Function (PUF)

PUFs are used to create a unique response by using implicit or explicit randomness. Implicit randomness is unpredictable manufacturing differences, for example, in semiconductor devices, which can be exploited to create a device-unique response. Explicit randomness, on the other hand, means that the introduction of randomness requires extra steps during manufacturing or a later stage, e.g., at packaging. To create a response from the PUF, which is sometimes referred to herein as a “PUF response,” the PUF is fed with a challenge, which is usually a binary string of a fixed length. This response or a combination of several responses can be used for cryptographic or device identity purposes. The benefit of using a PUF is that two identical PUFs on different devices or components may result in different responses when the two identical PUFs are fed with the same challenge. Hence, because of the different responses from the two identical PUFs that are fed with the same challenge, the PUF is literally “unclonable.” Physical unclonability of the PUF is a property that makes it easy to create a random PUF instance, but hard to create a specific instance. Physical unclonability of the PUF assumes that a clone is manufactured in the same production process as the original device.

A PUF may comprise one or several subfunctions, each contributes with a part of the PUF response. The followings are three examples of the subfunctions. First, ring-oscillators can be used an a subfunction. In particular, a ring-oscillator includes an uneven number of signal inverters in a ring and uses gate delay propagation as a randomness source. The response is a comparison between two or more ring-oscillators where the number of oscillations at a given point is measured. The result can, e.g., be the identifier of the fastest or slowest ring oscillator. Second, uninitialized Static Random Access Memory (SRAM) cells have two possible states (0 and 1). Prior to power up, the cell is in neither state. At power up, the cell stabilizes in one of the two states. The response is the entered state. Third, an arbiter circuit can be used as a subfunction. In this case, the subfunction utilizes a digital race condition between two or more signal paths on a chip where a so-called arbiter circuit identifies the winning signal. The paths may comprise several switch blocks, which can alter the signal paths.

The PUF response can be used to create a device unique identity or a device unique key, without having to store the identity/key in, e.g., Battery Backed Random Access Memory (BBRAM) or One Time Programmable (OTP) memory. Hence, it is much harder for an attacker to steal a key from a device using the PUF, as the key is never stored on the device.

Most PUF types additionally require error correcting codes, which are often denoted as “helper data”, to function properly, i.e., to increase the possibility of recreating the same response given the same challenge. This may require the PUF to go through an enrollment process, where unstable bits in the PUF response may be removed and the helper data may be created and stored. As the randomness in the PUF may be biased, a fuzzy extractor may be used to perform both error correction and increase the uniformity of the randomness. In these cases, the fuzzy extractor takes the PUF response as an input and produces outputs a deterministic but uniformly random binary string.

When a PUF response, or a derivation thereof, is used to encrypt another cryptographic key, the PUF response is referred to as a “Key Encryption Key” (KEK).

### Measured Boot, Trusted Boot, and Secure Boot

Measured boot includes measuring (e.g., hashing) every component loaded on the system (e.g., having the PUF) and storing the result in a boot register of the system. Such boot register is usually extendable rather than directly writable, e.g., as expressed by Rt+1=OWF (Rt∥ArgumentOfExtend). The result stored in the boot register can either be a hash chain, each individual hash, or a combination of the two.

Trusted boot is basically measured boot but with validation of the values during the boot process. In other words, the device (e.g., the device having the PUF) itself knows what measurements to expect and, if the measurements differ, the device does not boot or enters a secure state.

Secure boot requires the use of cryptographic signatures which has to be rooted in a so-called root-of-trust (RoT). This is usually a fused key, which may either be unique for each device or a vendor key reused for many devices.

### Trusted Computing Group (TCG) Device Identifier Composition Engine (DICE)

The TCG has created a framework called DICE where software layers are provided with unique identities and keys where the Key Derivation Function (KDF) includes parameters based on the loaded software. Typically, a software layer or Read Only Memory (ROM) would measure or hash the next software component to be loaded and perform a key derivation where the measured value is included into the KDF. The resulting key will be used by the next software component when loaded and so on. Hence, patching of a software component results in a new key and identity automatically.

### Hardware Attacks

During the last decade, so-called invasive hardware attacks have decreased in cost. Several kits are now available that help an attacker to scan for debug pins such as Joint Test Action Group (JTAG) pins and to identify buses which can be probed. Such kits can be utilized for an attacker to tap into the device or even to reroute information to external components.

The most powerful invasive weapon for an attacker is a Focused Ion Beam (FIB), which is available including operating engineers, for merely ~$500/hour. For example, a FIB can reroute signal paths, disable components, or reprogram OTP memory.

Furthermore, the trend of utilizing cloud and edge services opens up new attack vectors. Hardware components in cloud deployments can be altered and replaced, which is very hard to detect for a cloud tenant utilizing hardware.

### Related Art

United States Patent Application Publication 2021/0314365 A1 (titled “End-to-end device attestation”) describes a method for attesting hardware. The hardware is divided into two layers, where a first layer attests the characteristics of a second layer. The characteristics of the second hardware layer is described by firmware, read-only memory, storage memory, fuses, straps, soft straps, or electronic fuses. Once the second hardware layer is attested, it may be utilized to be attest a software layer. This published patent application briefly mentions a PUF as a possible alternative implementation of fuses.

Using a single device PUF to create a key which acts as a RoT, e.g., for a boot sequence is known and utilized by several products on the markets today. For example, in Xilinx, Xilinx Ultrascale+ Device, Technical Reference Manual, UG 1085 (v2.2), (December 4, 2020), available at https://docs.xilinx.com/v/u/en-US/ug1085-zynq-ultrascale-trm, a PUF is used to create a KEK for a boot encryption key.

There is also some related art concerning the utilization of several PUFs on the same platform, e.g., by utilizing different entropy sources. U.S. Pat. No. 8,699,714 B2 (titled “Distributed PUF”) describes a solution where several different memory components are used to create a unified PUF response, and U.S. Pat. No. 9,558,358 B2 (titled “Random number generator in a virtualized environment”) describes a method to utilize different entropy sources in a virtual environment to create a “virtual PUF.”

### SUMMARY

Systems and methods on an extended boot key derivation framework are provided. In one embodiment, a method performed by a master hardware module in a device comprising the master hardware module and at least a first subsequent hardware module comprises generating a Unique Module Secret (UMS) of the master hardware module, deriving secret of the master hardware module (secret_HM0) based on the UMS of the master hardware module (UMS_HM0) and a Security Descriptor (SD) of the master hardware module (SD_HM0_L0) using a first Key Derivation Function (KDF) of the master hardware module, further generating an asymmetric key pair of the master hardware module (DeviceID) based on the secret of the master hardware module (secret_HM0) using a function, and receiving a UMS of the first subsequent hardware module (UMS_HM1) and a first SD of the first subsequent hardware module (SD_HM1_L0) from the first subsequent hardware module. By this way, it is possible to make boot-generated keys dependent on not only the firmware/software/bitstreams but also a hardware module-unique secret. Since the hardware module contains a unique fingerprint or secret that should be difficult to physically clone, it is very difficult for an attacker to replace the hardware module without the generated keys and identities being incorrectly generated.

In one embodiment, the step of generating the UMS of the master hardware module (UMS_HM0) comprises generating the UMS of the master hardware module by activating at least one Physically Unclonable Function (PUF) circuitry and reading data from at least one output from the PUF circuitry.

In one embodiment, the step of generating the UMS of the master hardware module (UMS_HM0) comprises generating the UMS of the master hardware module by reading data stored in non-volatile memory.

In one embodiment, the step of generating the UMS of the master hardware module (UMS_HM0) further comprises post-processing the data using one or more of a) one-way transformation and b) error-correcting circuitry.

In one embodiment, the first subsequent hardware module generates and provides the UMS of the first subsequent hardware module (UMS_HM1) to the master hardware module via an interface. The first subsequent hardware module receives the first secret of the first subsequent hardware module (secret_HM1_L0) from the master hardware module after providing the first SD of the first subsequent hardware module (SD_HM1_L0) to the master hardware module. The first subsequent hardware module generates a first asymmetric key pair of the first subsequent hardware module (ComponentID_HM1) based on the first secret of the first subsequent hardware module (secret_HM1_L0) using a function of the first subsequent hardware module. The first subsequent hardware module generates a second asymmetric key pair of the first subsequent hardware module (Alias_HM1_L1_ID) and a second secret of the first subsequent hardware module (secret_HM1_L1) based on a second SD of the first subsequent hardware module (SD_HM1_L1) and the first secret of the first subsequent hardware module (secret_HM1_L0) using a KDF of the first subsequent hardware module. The first subsequent hardware module signs a public key in the second asymmetric key pair of the first subsequent hardware module (Alias_HM1_L1_ID) with the first asymmetric key pair of the first subsequent hardware module (ComponentID_HM1).

In one embodiment, the method further comprises generating a first asymmetric key pair of the first subsequent hardware module (ComponentID_HM1) based on the secret of the master hardware module (secret_HM0), the UMS of the first subsequent hardware module, the first SD of the first subsequent hardware module (SD_HM1_L0) using the second KDF of the master hardware module, providing the first asymmetric key pair of the first subsequent hardware module (ComponentID_HM1) to the first subsequent hardware module, and signing a public key in the first asymmetric key pair of the first subsequent hardware module (ComponentID_HM1) with the asymmetric key pair of the master hardware module (DeviceID).

In one embodiment, the first subsequent hardware module receives the first secret of the first subsequent hardware module (secret_HM1_L0) from the master hardware module after providing the first SD of the first subsequent hardware module (SD_HM1_L0) to the master hardware module. The first subsequent hardware module generates a second asymmetric key pair of the first subsequent hardware module (Alias_HM1_L1_ID) and a second secret of the first subsequent hardware module (secret_HM1_L1) based on a second SD of the first subsequent hardware module (SD_HM1_L1) and the first secret for the first subsequent hardware module (secret_HM1_L0) using a KDF of the first subsequent hardware module. The first subsequent hardware module signs a public key in the second asymmetric key pair of the first subsequent hardware module (Alias_HM1_L1_ID) with the first private key of the first subsequent hardware module (ComponentID_HM1).

In one embodiment, the method further comprises determining whether there is a second subsequent hardware module. When it is determined that there is the second subsequent hardware module, the method further comprises receiving a UMS of the second subsequent hardware module (UMS_HM2) and a first SD of the second subsequent hardware module (SD_HM2_L0) from the second subsequent hardware module. The UMS of the second subsequent hardware module is generated by the second subsequent hardware module. The method further comprising generating a first secret for HM2 (secret_HM2_L0) based on the secret of the master hardware module (secret_HM0), the UMS of the second subsequent hardware module, and the first SD of the second subsequent hardware module (SD_HM2_L0) using a second KDF of the master hardware module, and providing the first secret for the second subsequent hardware module (secret_HM2_L0) to the second subsequent hardware module.

In one embodiment, the function is a probabilistic algorithm to derive an asymmetric key pair from a symmetric seed.

In one embodiment, a method performed by a master hardware module in a device comprising the master hardware module and at least a first subsequent hardware module comprises generating an UMS of the master hardware module (UMS_HM0), deriving a secret of the master hardware module (secret_HM0) based on the UMS (UMS_HM0) and a SD of the master hardware module (SD_HM0_L0) using a first KDF of the master hardware module, deriving a first state (state_1), generating an asymmetric key pair of the master hardware module (DeviceID) based on the secret of the master hardware module (secret_HM0) using a function, receiving an UMS of the first subsequent hardware module (UMS_HM1) and a first SD of the first subsequent hardware module (SD_HM1_L0) from the first subsequent hardware module, generating a first asymmetric key pair of the first subsequent hardware module (ComponentID_HM1) and a first secret for the first subsequent hardware module (secret_HM1_L0) based on the first state (state_1), the UMS of the first subsequent hardware module, and the first SD of the first subsequent hardware module (SD_HM1_L0) using a second KDF of the master hardware module, deriving a second state (state_2), providing the first asymmetric key pair of the first subsequent hardware module (ComponentID_HM1) and the first secret for the first subsequent hardware module (secret_HM1_L0) to the first subsequent hardware module, and signing a public key in the first asymmetric key pair of the first subsequent hardware module (ComponentID_HM1) with the asymmetric key pair of the master hardware module (DeviceID).

In one embodiment, the method further comprises receiving an UMS of the second subsequent hardware module (UMS_HM2) and a first SD of the second subsequent hardware module (SD_HM2_L0) from the second subsequent hardware module. The UMS of the second subsequent hardware module is generated by the second subsequent hardware module. The method further comprises generating a first asymmetric key pair of the second subsequent hardware module (ComponentID_HM2) and a first secret for the second subsequent hardware module (secret_HM2_L0) based on the second state (state_2), the UMS of the second subsequent hardware module, and the first SD of the second subsequent hardware module (SD_HM2_L0) using a second KDF of the master hardware module, and signing a public key in the first asymmetric key pair of the second subsequent hardware module (ComponentID_HM2) with the asymmetric key pair of the master hardware module (DeviceID).

In one embodiment, the step of generating the UMS of the master hardware module (UMS_HM0) comprises generating the UMS of the master hardware module by activating at least one PUF circuitry and reading data from at least one output from the PUF circuitry.

In one embodiment, the step of generating the UMS of the master hardware module (UMS_HM0) comprises generating the UMS of the master hardware module by reading data stored in non-volatile memory.

In one embodiment, the step of generating the UMS of the master hardware module (UMS_HM0) further comprises post-processing the data using one or more of a) one-way transformation and b) error-correcting circuitry.

In one embodiment, the step of deriving the first state (state_1) comprises, utilizing a One Way Function (OWF) which takes, as an input, at least a previous state and at least one of: (a) a secret of a last hardware module booted, (b) a SD of the last hardware module booted, and (c) a UMS of the last hardware module booted.

In one embodiment, the step of deriving the second state (state_2) comprises, utilizing a OWF which takes, as an input, at least a previous state and at least one of: (a) a secret of a last hardware module booted, (b) a SD of the last hardware module booted, and (c) a UMS of the last hardware module booted.

In one embodiment, the first subsequent hardware module generates the UMS of the first subsequent hardware module (UMS_HM1) and provides the UMS of the first subsequent hardware module (UMS_HM1) to the master hardware module, via an interface. The first subsequent hardware module receives the first secret of the first subsequent hardware module (secret_HM1_L0) from the master hardware module after providing the first SD of the first subsequent hardware module (SD_HM1_L0) to the master hardware module. The first subsequent hardware module generates a second asymmetric key pair of the first subsequent hardware module (Alias_HM1_L1_ID) and a second secret of the first subsequent hardware module (secret_HM1_L1) based on the second SD of the first subsequent hardware module (SD_HM1_L1) and a secret for the first subsequent hardware module (secret_HM1_L0) using a KDF of the first subsequent hardware module.

In one embodiment, the function is a probabilistic algorithm to derive an asymmetric key pair from a symmetric seed.

In one embodiment, a method performed by a master hardware module in a device comprising the master hardware module and at least a first subsequent hardware module comprises generating an UMS of the master hardware module (UMS_HM0), deriving a secret of the master hardware module (secret_HM0) based on the UMS (UMS_HM0) and a SD of the master hardware module (SD_HM0_L0) using a first KDF of the master hardware module, deriving a first state (state_1), generating a first asymmetric key pair of the master hardware module (DeviceID) based on the secret of the master hardware module (secret_HM0) and the first state (state_1) using a first function, receiving an UMS of the first subsequent hardware module (UMS_HM1) and a first SD of the first subsequent hardware module (SD_HM1_L0) from HM1,generating a first asymmetric key pair of the first subsequent hardware module (ComponentID_HM1) and a first secret for HM1 (secret_HM1_L0) based on the first state (state_1), the UMS of the first subsequent hardware module, and the first SD of the first subsequent hardware module (SD_HM1_L0) using a second KDF of the master hardware module, deriving a second state (state_2), generating a second asymmetric key pair (AliasID) based on the second state (slate_2) using a second function, providing the first asymmetric key pair of the first subsequent hardware module (ComponentID_HM1) and the first secret for HM1 (secret_HM1_L0) to the first subsequent hardware module, signing a public key in the second asymmetric key pair (AliasID) with the asymmetric key pair of the master hardware module (DeviceID), and signing a public key in the first asymmetric key pair of the first subsequent hardware module (ComponentID_HM1) with the second asymmetric key pair (AliasID).

In one embodiment, the step of generating the UMS of the master hardware module (UMS_HM0) comprises generating the UMS of the master hardware module by activating at least one PUF circuitry and reading data from at least one output from the PUF circuitry.

In one embodiment, the step of generating the UMS of the master hardware module (UMS_HM0) comprises generating the UMS of the master hardware module by reading data stored in non-volatile memory.

In one embodiment, the step of generating the UMS of the master hardware module (UMS_HM0) further comprises post-processing the data using one or more of a) one-way transformation and b) error-correcting circuitry.

In one embodiment, the step of deriving the first state (state_1) comprises, utilizing a OWF which takes, as an input, at least a previous state and at least one of: (a) a secret of a last hardware module booted, (b) a SD of the last hardware module booted, and (c) a UMS of the last hardware module booted.

In one embodiment, the step of deriving the second state (state_2) comprises, utilizing a OWF which takes, as an input, at least a previous state and at least one of: (a) a secret of a last hardware module booted, (b) a SD of the last hardware module booted, and (c) a UMS of the last hardware module booted.

In one embodiment, the first subsequent hardware module receives the first secret of the first subsequent hardware module (secret_HM1_L0) from the master hardware module after providing the first SD of the first subsequent hardware module (SD_HM1_L0) to the master hardware module. The first subsequent hardware module generates an asymmetric key pair of the first subsequent hardware module (Alias_HM1_L1_ID) and a second secret of the first subsequent hardware module (secret_HM1_L1) based on a second SD of the first subsequent hardware module (SD_HM1_L1) and a secret for the first subsequent hardware module (secret_HM1_L0) using a KDF of the first subsequent hardware module. The first subsequent hardware module signs a public key in the second asymmetric key pair of the first subsequent hardware module (Alias_HM1_L1_ID) with the first asymmetric key pair of the first subsequent hardware module (ComponentID_HM1).

In one embodiment, the first function or the second function is a probabilistic algorithm to derive an asymmetric key pair from a symmetric seed.

Corresponding embodiments of the master hardware module and the subsequent hardware module are also enclosed.

In one embodiment, a master hardware module in a device comprising the master hardware module and at least a first subsequent hardware module is adapted to generate a UMS of the master hardware module (UMS_HM0), derive a secret of the master hardware module (secret_HM0) based on the UMS of the master hardware module (UMS_HM0) and a SD of the master hardware module (SD_HM0_L0) using a first KDF of the master hardware module, generate an asymmetric key pair of the master hardware module (DeviceID) based on the secret of the master hardware module (secret_HM0) using a function, and receive a UMS of the first subsequent hardware module (UMS_HM1) and a first SD of the first subsequent hardware module (SD_HM1_L0) from the first subsequent hardware module.

In one embodiment, a master hardware module in a device comprising the master hardware module and at least a first subsequent hardware module is adapted to generate an UMS of the master hardware module (UMS_HM0), derive a secret of the master hardware module (secret_HM0) based on the UMS (UMS_HM0) and a SD of the master hardware module (SD_HM0_L0) using a first KDF of the master hardware module, derive a first state (state_1), generate an asymmetric key pair of the master hardware module (DeviceID) based on the secret of the master hardware module (secret_HM0) using a function, receive an UMS of the first subsequent hardware module (UMS_HM1) and a first SD of the first subsequent hardware module (SD_HM1_L0) from the first subsequent hardware module, generate a first asymmetric key pair of the first subsequent hardware module (ComponentID_HM1) and a first secret for the first subsequent hardware module (secret_HM1_L0) based on the first state (state_1), the UMS of the first subsequent hardware module, and the first SD of the first subsequent hardware module (SD_HM1_L0) using a second KDF of the master hardware module, derive a second state (state_2), provide the first asymmetric key pair of the first subsequent hardware module (ComponentID_HM1) and the first secret for the first subsequent hardware module (secret_HM1_L0) to the first subsequent hardware module, and sign a public key in the first asymmetric key pair of the first subsequent hardware module (ComponentID_HM1) with the asymmetric key pair of the master hardware module (DeviceID).

In one embodiment, a master hardware module in a device comprising the master hardware module and at least a first subsequent hardware module is adapted to generate an UMS of the master hardware module (UMS_HM0), derive a secret of the master hardware module (secret_HM0) based on the UMS (UMS_HM0) and a SD of the master hardware module (SD_HM0_L0) using a first KDF of the master hardware module, derive a first state (state_1), generate a first asymmetric key pair of the master hardware module (DeviceID) based on the secret of the master hardware module (secret_HM0) and the first state (state_1) using a first function, receive an UMS of the first subsequent hardware module (UMS_HM1) and a first SD of the first subsequent hardware module (SD_HM1_L0) from the first subsequent hardware module, generate a first asymmetric key pair of the first subsequent hardware module (ComponentID_HM1) and a first secret for the first subsequent hardware module (secret_HM1_L0) based on the first state (state_1), the UMS of the first subsequent hardware module and the first SD of the first subsequent hardware module (SD_HM1_L0) using a second KDF of the master hardware module, derive a second state (state_2), generate a second asymmetric key pair (AliasID) based on the second state (slate_2) using a second function, provide the first asymmetric key pair of the first subsequent hardware module (ComponentID_HM1) and the first secret for the first subsequent hardware module (secret_HM1_L0) to the first subsequent hardware module, and sign a public key in the first asymmetric key pair of the first subsequent hardware module (ComponentID_HM1) with the second asymmetric key pair (AliasID).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an overview of Trusted Computing Group (TCG) Device Identifier Composition Engine (DICE).

FIG. 2 illustrates an overview of blocks in a device involved in the present disclosure.

FIG. 3 illustrates one example embodiment of a first solution proposed in accordance with some embodiments of the present disclosure.

FIG. 4A illustrates one flow diagram on the example embodiment of the first solution proposed in accordance with some embodiments of the present disclosure.

FIG. 4B illustrates another flow diagram on the example embodiment of the first solution proposed in accordance with some embodiments of the present disclosure.

FIG. 5 illustrates one example embodiment of a second solution proposed in accordance with some embodiments of the present disclosure.

FIG. 6 illustrates a flow diagram on the example embodiment of the second solution proposed in accordance with some embodiments of the present disclosure.

FIG. 7 illustrates one example embodiment of a third solution proposed in accordance with some embodiments of the present disclosure.

FIG. 8 illustrates a flow diagram on the example embodiment of the third solution proposed in accordance with some embodiments of the present disclosure.

FIG. 9 illustrates one example embodiment of a fourth solution proposed in accordance with some embodiments of the present disclosure.

FIG. 10 illustrates a flow diagram on the example embodiment of the fourth solution proposed in accordance with some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

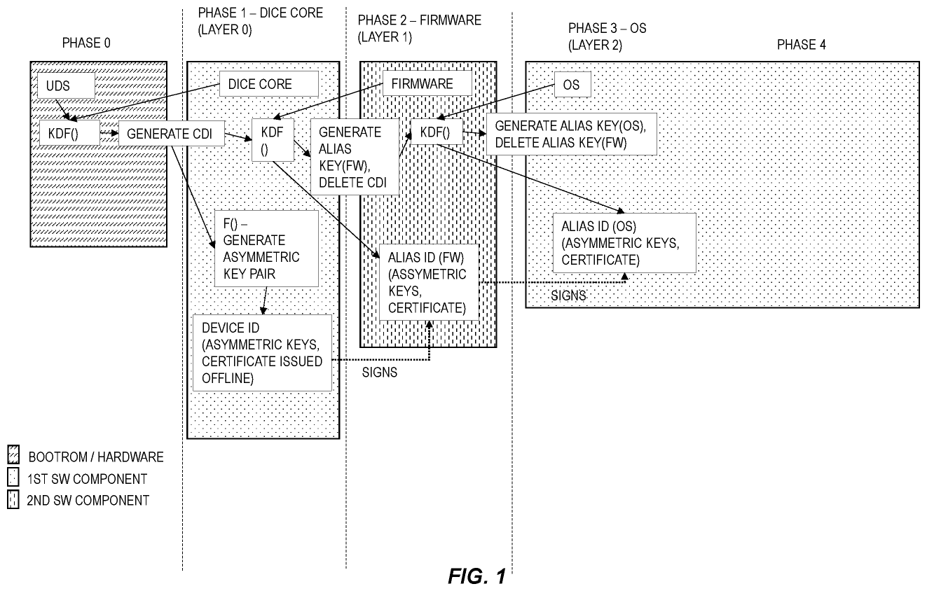

Current identity and key derivation schemes, like Trusted Computing Group (TCG) Device Identifier Composition Engine (DICE), only take into consideration the software (SW) and the firmware (FW). They do not incorporate any information regarding the hardware (HW) and, particularly, do not incorporate any information regarding not what modules or components are comprised in the HW. FIG. 1 illustrates an overview of the TCG DICE framework.

United States Patent Application Publication 2021/0314365 A1 (titled “End-to-end device attestation”) mitigates the aforementioned issue in the TCG DICE framework by measuring the state of the HW prior to boot but does not protect against malicious hardware module replacements, e.g., using spoofed values.

Several contemporary solutions which leverage a single Physically Unclonable Function (PUF) as root-of-trust (RoT) for trusted boot exists. However, in Xilinx's Ultrascale+ device document (Xilinx, Xilinx Ultrascale+ Device, Technical Reference Manual, UG 1085 (v2.2), (December 4, 2020), available at https://docs.xilinx.com/v/u/en-US/ug1085-zynq-ultrascale-trm), these contemporary solutions are aimed at protecting or generating a single root key for the device. Such schemes cannot detect hardware replacements.

The present disclosure describes an extended boot key derivation framework where a hardware module and firmware unique keys are generated. The present disclosure is aligned with or can be seen as an extension of, the device key derivation process described in the TCG-DICE framework, but is not limited thereto.

In the present disclosure, a device includes multiple hardware modules. Each hardware module has its own Unique Module Secret (UMS), which is aligned with TCG-DICE Unique Device Secret (UDS). The UMS is required to be physically unclonable but only the UMS of a master hardware module is required to be secret.

In one embodiment, in the boot process, the master hardware module boots first and utilizes its UMS to generate a first secret that is passed on to a first loadable component, such as SW, FW, or a bitstream (BS), loaded on the master hardware module. This first secret is used to generate credentials and identities for a second SW component started on the master hardware module.

In one embodiment, a second hardware module on the device supplies its UMS to the master hardware module during initialization. The master hardware module uses the second hardware module's UMS and its own UMS to generate credentials and identities for a first loadable component on a second hardware module.

In one embodiment, by utilizing both the master hardware module's UMS and any subsequent hardware modules' UMS, any generated credentials and identities require that all of the hardware modules (i.e., the master hardware module and the subsequent hardware modules) are genuine and have not been replaced.

Embodiments of the present disclosure may, for example, be used in the following settings. As a first example, embodiments of the present disclosure may be used in an encrypted data setting where the correct credentials are needed to decrypt data and, if a hardware component is maliciously replaced, loaded components on the replaced hardware module cannot decrypt data. This is advantageous, e.g., in an encrypted boot-like scenario, where each step needs to generate a key to decrypt the next step in the boot sequence. Second, embodiments of the present disclosure may be used in a trusted boot setting where boot stops for illegal credentials and the master hardware module has a storage of expected credentials, e.g., the corresponding public keys for the generated private keys.

In one embodiment, a system or a device includes multiple hardware modules. At least one hardware module produces a unique output, partly or fully, generated by a UMS. At least a first of the hardware modules receives the UMS from a second hardware module, and a security descriptor (describing a loadable component) associated with a loadable component for the second hardware module is performed. The first hardware module returns a first secret based on the UMS from the first hardware module, the UMS from the second hardware, and the security descriptor associated with a loadable component for the second hardware module.

In one embodiment, the second hardware module may additionally be configured to further generate subsequent secrets based on additional SW measurements and a previously generated secret (e.g., using the first secret to generate a second secret). In one embodiment, the security descriptor is based on a) metadata for the loadable component, b) a part of or the full loadable component, c) a hash of the loadable component, d) any combination of a)-c).

In one embodiment, the loadable component may comprise a FW, a SW, a bitstream, or a configuration loaded on the second hardware module. In one embodiment, the UMS comprises a) an output from a PUF, b) an output from a parametrized One Way Function (OWF) (such as a Message Authentication Code (MAC) function), c) a secret stored in Non-Volatile Memory (NVM) or d) a combination of a) c). In one embodiment, the UMS is additionally based on a) hardware metadata, b) sensor readings, c) self-attestation results, or d) a hardware configuration.

The present disclosure also comprises a method for creating a measured boot sequence where the SW components' key material and identities are dependent on the security descriptor (SW/FW/BS) but also a unique UMS embedded in each module. Solutions in the present disclosure make it possible to make boot-generated keys dependent on not only the SW/FW/BS but also a hardware module-unique secret. Since the hardware module contains a unique ‘fingerprint’ or secret that should be difficult to physically clone, it is very difficult for an attacker to replace the hardware module without the generated keys and identities being incorrectly generated.

The present disclosure can advantageously be combined with metadata and Built-In Self-Test (BIST) functionality to ensure correct functioning and correct deployed hardware. The present disclosure raises the bar for an attacker, as creating a component with an equal PUF response cannot be easily done, since the PUF per definition is unclonable.

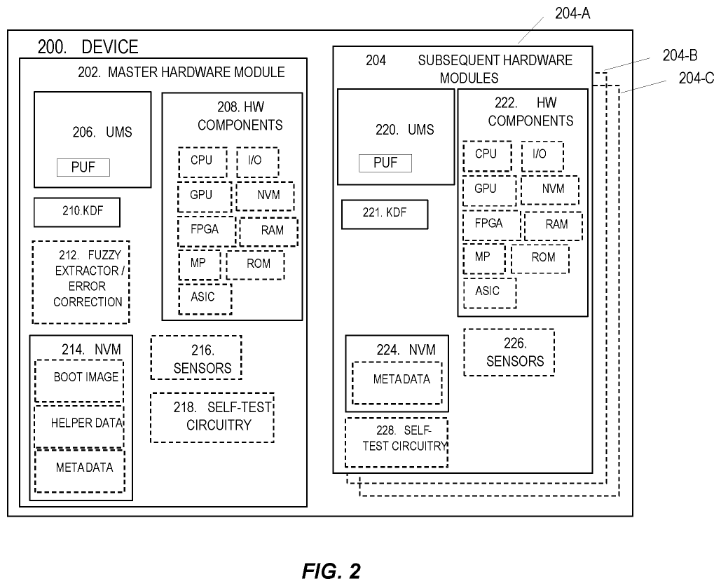

FIG. 2 illustrates an overview of blocks in a device 200 involved in the present disclosure. Dotted lines indicate optional blocks. As illustrated, the device 200 includes multiple hardware modules, where the hardware module 202 is also referred to herein as a master hardware module 202 and the remaining hardware modules 204-A to 204-n are also referred to herein as subsequent hardware modules.

The master hardware module 202 comprises an UMS 206 and one or more HW components 208. The UMS 206 may be generated using a PUF, a value stored in Non-volatile memory (NVM), such as One Time Programmable (OTP) memory and/or an OWF.

The PUF is used to create a unique response by using implicit or explicit randomness. This response can be used for cryptographic or device identity purposes. Implicit randomness may include unpredictable manufacturing differences in semiconductor devices that can be exploited to create a device-unique response. On the other hand, explicit randomness means that the introduction of randomness requires extra steps during manufacturing or a later stage, e.g., at packaging.

The OTP is a special type of non-volatile memory (NVM) that permits data to be written to memory only once. Once the memory has been programmed, it retains its value upon loss of power (i.e., is non-volatile).

The OWF is a function that is easy to compute on every input, but hard to invert given the image of a random input. Examples of the OWF are MAC functions and hash functions such as the SHA and BLAKE families.

The HW components 208 may include, e.g., a Central Processing Unit (CPU), an Input/Output (I/O), a Graphic Processing Unit (GPU), a Non-Volatile Memory (NVM), a Field Programmable Gate Array (FPGA), a Random Access Memory (RAM), a MicroProcessor (MP), a Read Only Memory (ROM), and/or an Application Specific Integrated Circuit (ASIC).

The master hardware module 202 also includes a KDF 210. The KDF 210 creates a cryptographic key from the PUF response. Depending on the cryptographic algorithm, the KDF 210 may comprise different components. For a cryptographic algorithm accepting uniform randomness as a key, a OWF such as a MAC function or a hash function could be used. In other cases, a more complex KDF function that creates a key satisfying a specific criterion of the cryptographic algorithm is needed. Examples of the KDF 210 are Argon2, Scrypt, and Password-Based Key Derivation Function 2(PBKDF2).

Optionally, the master hardware module 202 may comprise a fuzzy extractor or error correction function 212. Also, the master hardware module 202 includes a NVM 214, which may optionally store, e.g., a boot image, a helper data (i.e., error correcting codes to be used by the error correction function 212 to correct erroneous bits in a PUF response), and/or a metadata regarding the hardware module, e.g., manufacturer and version. Optionally, the master hardware module 202 may comprise sensors 216 and/or a self-test circuitry 218.

Each of the subsequent hardware modules (e.g., a first subsequent hardware module 204-A) may be embodied fully or party by an integrated module such as, e.g., a chip, chiplets, system-on-chip, network-on-chip, or the like or an external module such as, e.g., an accelerations card, external RAM, disk storage, or the like connected to the master hardware module 202 via a shared memory or via an external bus such as Peripheral Component Interconnect Express (PCIE), Serial Advanced Technology Attachment (SATA), Universal Asynchronous Receiver-Transmitter (UART), Serial Peripheral Interface (SPI), I2C, Universal Serial Bus (USB-C), Ethernet or similar.

Using the subsequent hardware module 204-A as an example, the subsequent hardware module 204-A includes a UMS 220, which may be generated using a PUF, a value stored in Non-volatile memory (NVM), such as One Time Programmable (OTP) memory, or an OWF. The subsequent hardware module 204-A also includes another set of the HW components 222 and 204-A a NVM 224, which may optionally store a metadata regarding the hardware module, e.g., manufacturer and version. Further, the subsequent hardware module 204-A may optionally comprise sensors 226 and/or self-test circuitry 228.

In one embodiment, each HW component 208 provides an input to the respective KDF 210. The input may be from an HW unique secret, an HW specific PUF measurement, an identity, a measured HW component, FW, or a metadata response, or the like. Such information can be utilized as an input to key derivations and to create HW component specific keys and identities. A replaced HW/SW component will, hence, not be able to extract encrypted data or masquerade as the previous HW/SW component.

In regard to the solutions proposed in the present disclosure, the follow description starts by describing the apparatus and continues with how embodiments of the first solution could be applied to a boot key generation scenario. Each hardware module is equipped with a unique identity (e.g., an asymmetric key pair) and secret credential (e.g., a symmetric key) that depends on both the hardware module itself and the software component it loads. In this manner, hardware-entangled key generation is provided.

More specifically, as described above, the device 200 includes the multiple hardware modules 202 and 204. The master hardware module 202 may be embodied by a hardware module containing the means to execute a Trusted Execution Environment (TEE). Typically, the master hardware module 202 initiates and enforces a secure boot procedure. The other hardware modules are referred to as ‘subsequent’ hardware modules 204-A, 204-B, . . . 204-n (e.g., secondary/tertiary etc. depending on the order they are initialized/booted). Each of the hardware modules 202, 204-A, . . . , 204-n is equipped with an UMS (i.e., UMS 206 for the master hardware module 202 and UMS 220 for each subsequent hardware module 204-A, . . . , 204-n), where each UMS is similar to TCG DICE-specified UDS). This UMS is used to derive a unique identity and credential for the hardware module 204-A. To ensure the integrity of the device 200, these UMSs must not be easily spoofed or cloned.

In one embodiment, this issue is solved by embodying each of the UMSs (i.e., the UMS 206 of the master hardware module 202 and the UMS 220 of each of the subsequent hardware modules 204-A, . . . , 204-n) as the output of a PUF on the respective hardware module 202, 204-A, . . . , 204-n. While the PUF is a preferred choice due to the unclonable properties of the PUF, it is not the only possible implementation option for the unique function. Alternatives to using the PUF are described in the section below entitled “Other solutions (UMS implementation alternatives)”.

In one embodiment, the PUF is considered to have a single challenge-response pair that does not change over time. In a further embodiment (see the section below entitled “Other solutions (UMS dependent on input and/or hardware status)”), the PUF takes a challenge, either created from an external input or an internal input, which may alter the PUF response. This may be used to revoke a compromised key

The UMS 206 of the master hardware module 202 is treated as a secret and must never be exposed outside of the device 200. The UMS 220 for the other modules (e.g., the first subsequent hardware module 204-A) is not necessarily secret but required to be unclonable. In other words, an attacker who replaces a hardware module must not be able to recreate the same UMS.

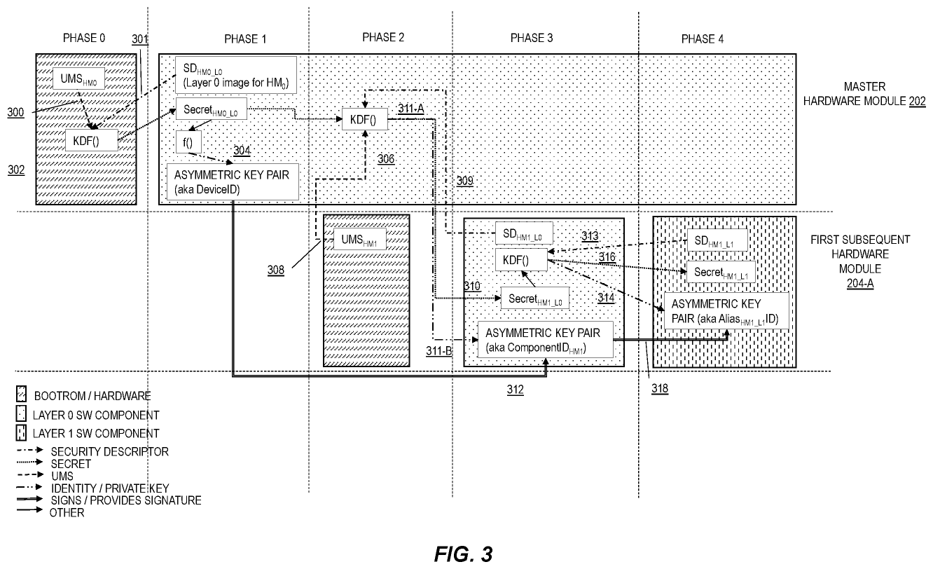

Embodiments of the present disclosure may advantageously be utilized during the boot process of the device 200. In this regard, the operation of the device 200 can be divided into an initial phase (phase 0) and subsequent phases (phases 1 to 4). Those phases are illustrated in each of FIGS. 3, 5, 7, and 9, which are described in detail below.

### First Solution

FIG. 3 illustrates a first embodiment proposed in accordance with some embodiments of the present disclosure. In the first embodiment illustrated in FIG. 3, the master hardware module 202 is responsible for deriving and signing identities of the subsequent hardware modules 204-A, . . . 204-n. That is, the master hardware module 202 is a RoT for all subsequent hardware modules 204-A, . . . , 204-n.

In the example of FIG. 3, the master hardware module 202 initializes (e.g., power on, triggering reset, or performing an action that makes the boot ROM for the subsequent module start to execute) two subsequent hardware modules 204-A, 204-B and derives a secret and an identity using the KDF 210. The KDF 210 does not retain any state and, therefore, produces the same secret/identity regardless of a boot order of the subsequent hardware modules 204-A, . . . , 204-n, such as, in this example, the first subsequent hardware module 204-A and the second subsequent hardware module 204-B.

In step 300, the UMS 206 of the master hardware module 202, which is also referred to herein as “UMS_{HM0}”, which may, e.g., be generated by ROM of the HW components 208 of the master hardware module 202, e.g., by activating at least one PUF circuitry and reading data from at least one output from the PUF circuitry, is supplied to the KDF 210, which also takes a Security Descriptor (SD) for a loadable component, e.g., FW/SW/BS. For example, as shown in step 301 of FIG. 3, the SD is “SD_{202_L0}” is a layer 0 image for the master hardware module 202 (“202”). However, the SD may additionally or alternatively include other information such as, for example, metadata for the loadable component (i.e., data about the loadable component), a hash of the loadable component, or the actual loadable component or part of the actual loadable component. Changes to the loadable component or the UMS_{HM0} thereby results in a different output from the KDF 210. Using these inputs, in step 302, the KDF 210 generates a secret denoted here as “secret_{HM0_L0}” (a symmetric key in phase 1 of FIG. 3). The KDF 210 may incorporate, e.g., a MAC function, a hash function, or a pseudorandom number generator (PRNG).

In step 304, the symmetric secret is, in turn, utilized to derive an identity (e.g., an asymmetric key pair) for the master hardware module 202. This derivation, denoted as “f( )” in the FIG. 3, represents a deterministic function to derive an asymmetric key pair from a symmetric seed. Alternatively, this derivation may be performed within the KDF. The secret and the identity are made available to the loadable component now running on the master hardware module 202. During production, or at a later stage, it is assumed that, for the master hardware module 202, a device certificate is issued for ‘DeviceID,’ which is stored in a NVM of the device 200. This certificate would typically be issued by the manufacturer. Once the loadable component has been initialized on the master hardware module 202, subsequent phases may begin.

During the subsequent phases (e.g., phases 1 to 4), the master hardware module 202 initializes one subsequent hardware module. In this example, in phase 1, the master hardware module 202 initializes the first subsequent hardware module 204-A. Thus, in step 308, the subsequent hardware module 204-A supplies its UMS 220 (UMS_{HM1}), or a key derived therefrom, 204-A to the master hardware module 202. In step 306, the master hardware module 202 inputs the master secret (Secret_{HM0_L0}), the received UMS 220 (UMS_{HM1}), and a descriptor of a loadable component (SD_{HM1_L0}) which will be used to boot the subsequent hardware module 204-A as inputs to the KDF 210 (KDF( ) in phase 2 of FIG. 3).

In step 310, the KDF 210 generates (Secret_{HM1_L0}) that can be used by the first subsequent hardware module 204-A to derive new identities and secrets for further loadable components such as, e.g., the Layer 1 SW component. The private key in the asymmetric key pair of the master hardware module (DeviceID) signs all subsequent module identities, i.e., the master hardware module 202 acts as a Certificate Authority (CA) and generates identities for each of the other hardware modules such as the first subsequent hardware module 204-A and the second subsequent hardware module 204-B.

Once the first subsequent hardware module 204-A has been initialized, the master hardware module 202 may continue to initialize other subsequent hardware modules (e.g., the second subsequent hardware module 204-B) using the same method as described for the first subsequent hardware module 204-A.

The subsequent hardware modules (such as 204-A) may also continue to derive new identities and a secret for further loadable components loaded on the same hardware module, e.g., the Layer 1 SW component. I.e., they act as intermediate CAS for their hardware module. The master hardware module 202 does not need to generate any explicit secret for these components as the subsequent hardware modules 204-A utilize the secret_{HMx} (e.g., “Secret” stored in the first subsequent hardware module 204-A, as shown in phase 3 of FIG. 3), which depends on secret_{HM0_L0} (in phase 1 of FIG. 3).

In the first embodiment shown in FIG. 3, the KDF 210 is deterministic and thereby generates the same result for the same combination of security descriptor+UMS+secret. Apart from the dependency on the master hardware module 202, the other hardware modules (e.g., the first subsequent hardware module 204-A and the second subsequent hardware module 204-B) are not dependent on each other. This makes it possible to boot the hardware modules in any order without changing the generated keys.

While the master hardware component 202 may not have any prior knowledge of other UMS, the master hardware component 202 may, if the UMS 206 (“UMS_{HM0}” in phase 0 of FIG. 3) is generated by the PUF, store error correcting codes to correct any errors that occurs during the generation of the UMS 206. In one embodiment, the master hardware module 202 may set up a shared memory region with the subsequent hardware modules (e.g., 204-A, 204-B) during initialization and thereby enable the subsequent hardware modules to perform error corrections during their respective generation of the UMS.

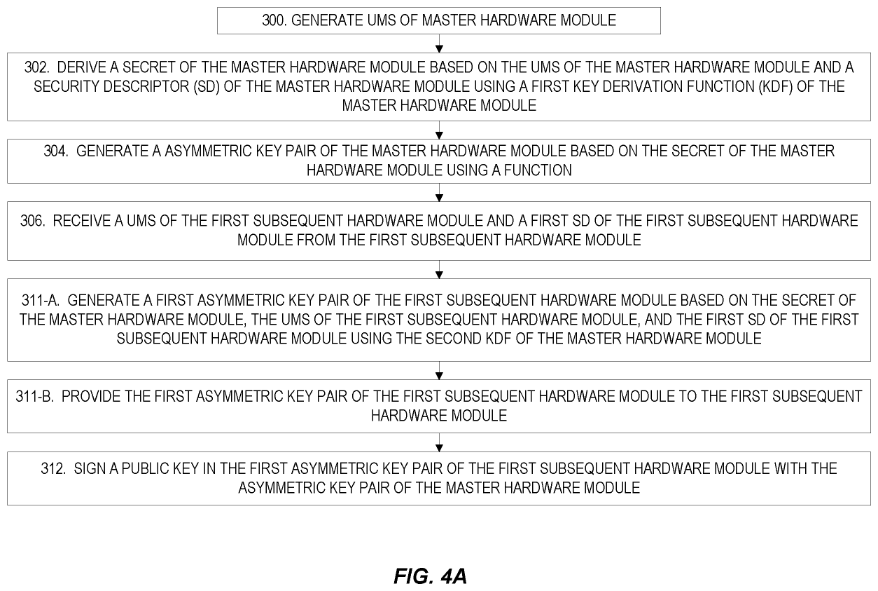

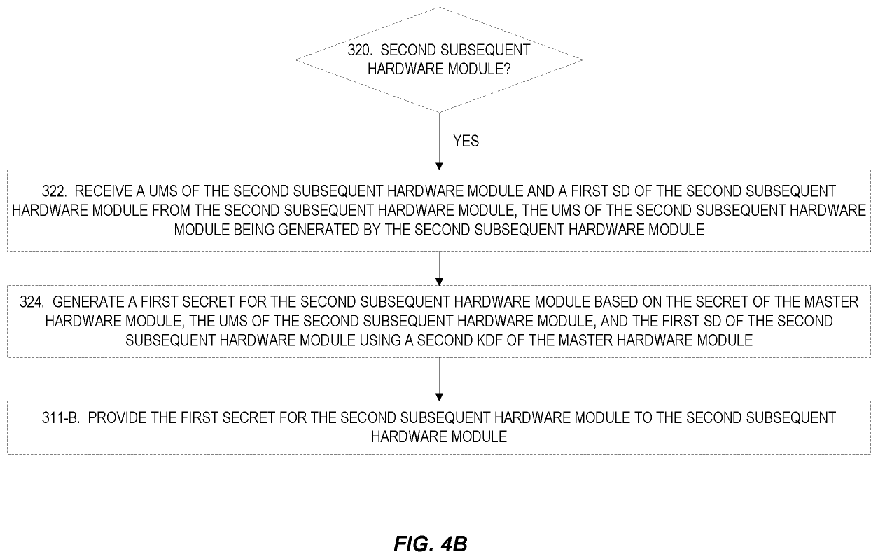

FIGS. 4A and 4B are a flow chart that illustrate the operation of the master hardware module 202 in accordance with one embodiment of the above-described first solution proposed in the present application and illustrated in FIG. 3. As such, the steps in the flow chart of FIG. 4A include reference numbers of the corresponding steps described above in relation to FIG. 3.

In step 300, the master hardware module 202 generates a UMS 206 of the master hardware module 202 (UMS_HM0). Optionally, the master hardware module 202 generates the UMS 206 of the master hardware module 202 by activating at least one PUF circuitry and reading data from at least one output from the PUF circuitry. Optionally, the master hardware module 202 generates the UMS of the master hardware module 202 by reading data stored in a non-volatile memory. Optionally, the master hardware module 202 performs post-processing the data using one or more of a) one-way transformation and b) error-correcting circuitry.

In step 302, the master hardware module 202 derives a secret of the master hardware module 202 (secret_HM0) based on the UMS of the master hardware module 202 (UMS_HM0) and a SD of the master hardware module 202 (SD_HM0_L0) using a first KDF of the master hardware module 202.

In step 304, the master hardware module 202 generates an asymmetric key pair of the master hardware module 202 (DeviceID) based on the secret of the master hardware module 202 (secret_HM0) using a function (f( ) in FIG. 3). Optionally, the function is a probabilistic algorithm to derive an asymmetric key pair from a symmetric seed. Alternatively, this derivation may be performed within the KDF.

In step 306, the master hardware module 202 receives a UMS of the first subsequent hardware module 204-A (UMS_HM1) and a first SD of the first subsequent hardware module 204-A (SD_HM1_L0) from the first subsequent hardware module 204-A.

In step 311-A, the master hardware module 202 generates a first asymmetric key pair of the first subsequent hardware module 204-A (ComponentID_HM1) based on the secret of the master hardware module 202 (secret_HM0), the UMS of the first subsequent hardware module 204-A, and the first SD of the first subsequent hardware module 204-A (SD_HM1_L0) using the second KDF of the master hardware module 202. The second KDF may either be equal to the first KDF or a different KDF.

In step 311-B, the master hardware module 202 provides the first asymmetric key pair of the first subsequent hardware module 204-A (ComponentID_HM1) to the first subsequent hardware module 204-A.

In step 312, the master hardware module 202 signs a public key in the first asymmetric key pair of the first subsequent hardware module 204-A (ComponentID_HM1) with the asymmetric key pair of the master hardware module 202 (DeviceID).

The following steps may be performed by the first subsequent hardware module 204-A for the first solution, as illustrated in FIG. 3.

In steps 309 and 310, the first subsequent hardware module 204-A receives the first secret of the first subsequent hardware module 204-A (secret_HM1_L0) from the master hardware module 202 after providing the first SD of the first subsequent hardware module 204-A (SD_HM1_L0) to the master hardware module 202.

In steps 313, 316, and 318, the first subsequent hardware module 204-A generates a second asymmetric key pair of the first subsequent hardware module 204-A (Alias_HM1_L1_ID) and a second secret of the first subsequent hardware module 204-A (secret_HM1_L1) based on a second SD of the first subsequent hardware module 204-A (SD_HM1_L1) and a secret for the first subsequent hardware module (secret_HM1_L0) using a KDF of the first subsequent hardware module 204-A.

In step 318, the first subsequent hardware module 204-A signs a public key in the second asymmetric key pair of the first subsequent hardware module 204-A (Alias_HM1_L1_ID) with the first private key of the first subsequent hardware module 204-A (ComponentID_HM1).

The master hardware module 202 may determine that there is a second subsequent hardware module 204-B (step 320, YES). Then, the master hardware module 202 receives a UMS of the second subsequent hardware module 204-B (UMS_HM2) and a first SD of the second subsequent hardware module 204-B (SD_HM2_L0) from the second subsequent hardware module 204-B. The UMS of the second subsequent hardware module 204-B is generated by the second subsequent hardware module 204-B (step 322).

Next, the master hardware module 202 generates a first secret for 204-B (secret_HM2_L0) based on the secret of the master hardware module 202 (secret_HM0), the UMS of the second subsequent hardware module 204-B, and the first SD of the second subsequent hardware module 204-B (SD_HM2_L0) using a second KDF of the master hardware module 202 (step 324). The second KDF may either be equal to the first KDF or a different KDF. Then, the master hardware module 202 provides the first secret for the second subsequent hardware module 204-B (secret_HM2_L0) to the second subsequent hardware module 204-B (step 326). The above steps 320 through 311-B may be repeated for other subsequent hardware modules 204-C, . . . , 204-n.

### Second Solution (Generation of Identities)

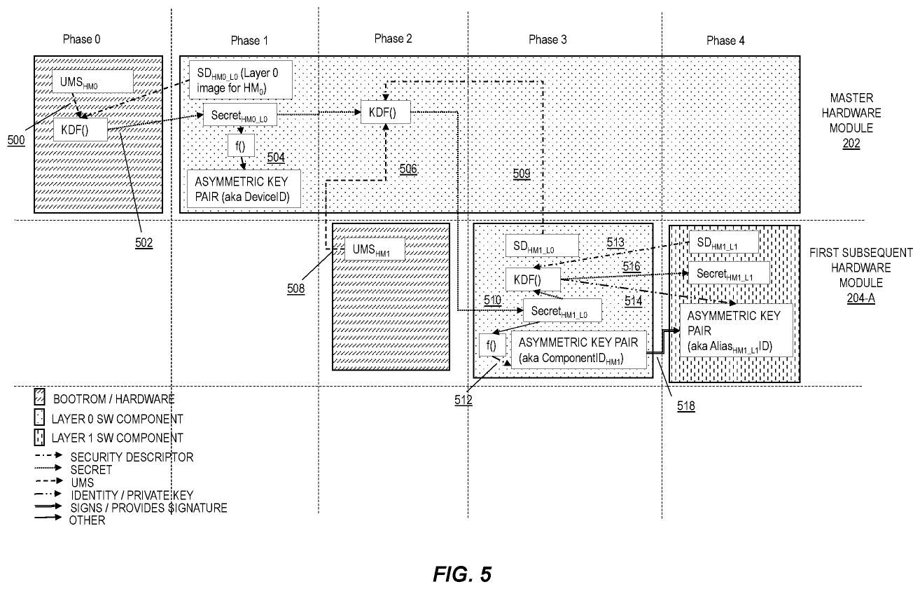

FIG. 5 illustrates one example embodiment of the second solution of the present disclosure. Specifically, FIG. 5 illustrates that the master hardware module 202 initializes the first subsequent hardware module 204-A and derives a secret for the first subsequent hardware module 204-A. In contrast to the first solution discussed above and illustrated in FIG. 3, the private key in FIG. 5 is generated by the first subsequent hardware module 204-A and is not signed by the master hardware module 202. In this second solution, each hardware module acts as its own RoT.

In one embodiment, the identity of the subsequent hardware module 204-A is derived from the secret for the subsequent hardware modules (e.g., the first subsequent hardware module 204-A, the second subsequent hardware module 204-B). In this case, each hardware module gets a “root identity” not signed by the master hardware module 202, i.e., trust for each hardware module needs to be established individually. However, the first subsequent hardware modules 204-A are still dependent on the master hardware module 202 as the first subsequent hardware modules 204-A utilize the secret_{HMx} that depends on the secret_{HM0_L0}. This approach may be useful in some scenarios where the signature of the module identity is not checked by an attesting party.

During the subsequent phases (e.g., phases 1 to 4), the master hardware module 202 initializes one subsequent hardware module. In this example, in phase 1, the master hardware module 202 initializes the first subsequent hardware module 204-A. Thus, in step 508, the subsequent hardware module 204-A supplies its UMS 220 (UMS_{HM1}). In step 506, the master hardware module 202 inputs the master secret (Secret_{HM0_L0}), the received UMS 220 (UMS_{HM1}), and a descriptor of a loadable component (SD_{HM1_L0}) which will be used to boot the subsequent hardware module 204-A as inputs to the KDF 210 (KDF( ) in phase 2 of FIG. 5).

In step 510, the KDF 210 generates Secret_{HM1_L0} that can be used by the first subsequent hardware module 204-A to derive new identities and secrets for further loadable components such as, e.g., the Layer 1 SW component.

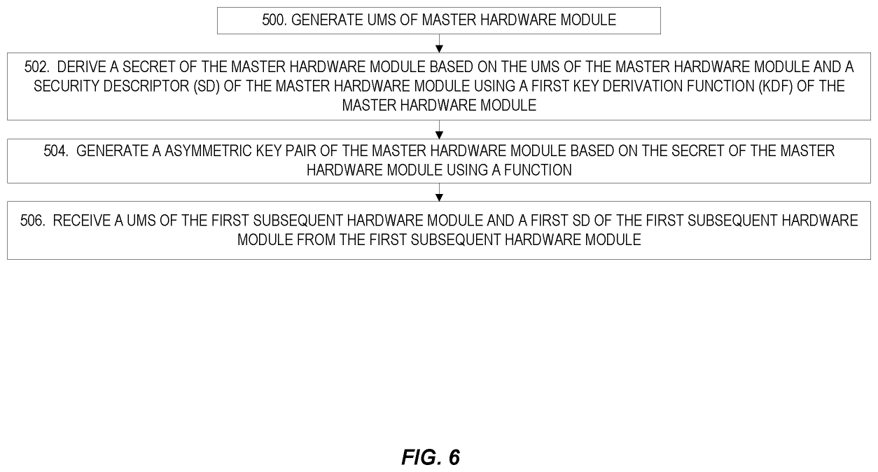

FIG. 6 illustrates a flow chart on the above-described second solution proposed in the present application and illustrated in FIG. 5.

In step 500, the master hardware module 202 generates a UMS of the master hardware module 202 (UMS_HM0). Optionally, the master hardware module 202 generates the UMS of the master hardware module 202 by activating at least one PUF circuitry and reading data from at least one output from the PUF circuitry. Optionally, the master hardware module 202 generates the UMS of the master hardware module 202 by reading data stored in a non-volatile memory. Optionally, the master hardware module 202 performs post-processing the data using one or more of a) one-way transformation and b) error-correcting circuitry.

In step 502, the master hardware module 202 derives a secret of the master hardware module 202 (secret_HM0) based on the UMS of the master hardware module 202 (UMS_HM0) and a SD of the master hardware module 202 (SD_HM0_L0) using a first KDF of the master hardware module 202.

In step 504, the master hardware module 202 generates an asymmetric key pair of the master hardware module 202 (DeviceID) based on the secret of the master hardware module 202 (secret_HM0) using a function (f( ) in FIG. 3). Optionally, the function is a probabilistic algorithm to derive an asymmetric key pair from a symmetric seed.

In step 506, the master hardware module 202 receives a UMS of the first subsequent hardware module 204-A (UMS_HM1) and in step 509, receives a first SD of the first subsequent hardware module 204-A (SD_HM1_L0) from the first subsequent hardware module 204-A. In step 510, the master hardware module 202 generates a first secret for the first subsequent hardware module using a KDF of the master hardware module 202.

In step 512, the first subsequent hardware module 204-A generates a first asymmetric key pair of the first subsequent hardware module 204-A (ComponentID_HM1) based on the first secret of the first subsequent hardware module 204-A (secret_HM1_L0) using a function of the first subsequent hardware module 204-A. In contrast to step 512 of FIG. 3, the example embodiment of the first solution (illustrated in FIG. 3) describes that the first asymmetric key pair of the first subsequent hardware module 204-A is provided by the master hardware module 202 (step 211-B).

The following steps may be performed by the first subsequent hardware module 204-A for the one example embodiment of the second solution, as illustrated in FIG. 5.

In steps 506 and 508, the first subsequent hardware module 204-A generates and provides the UMS of the first subsequent hardware module 204-A (UMS_HM1) to the master hardware module 202 via an interface.

In steps 509 and 510, the first subsequent hardware module 204-A receives the first secret of the first subsequent hardware module 204-A (secret_HM1_L0) from the master hardware module 202 after providing the first SD of the first subsequent hardware module 204-A (SD_HM1_L0) to the master hardware module 202.

In step 512, the first subsequent hardware module 204-A generates a first asymmetric key pair of the first subsequent hardware module 204-A (ComponentID_HM1) based on the first secret of the first subsequent hardware module 204-A (secret_HM1_L0) using a function of the first subsequent hardware module 204-A.

In steps 513, 514, and 516, the first subsequent hardware module 204-A generates a second asymmetric key pair of the first subsequent hardware module 204-A (Alias_HM1_L1_ID) and a second secret of the first subsequent hardware module 204-A (secret_HM1_L1) based on a second SD of the first subsequent hardware module 204-A (SD_HM1_L1) and a secret for the first subsequent hardware module (secret_HM1_L0) using a KDF of the first subsequent hardware module 204-A.

In step 518, the first subsequent hardware module 204-A signs a public key in the second asymmetric key pair of the first subsequent hardware module 204-A (Alias_HM1_L1_ID) with the first asymmetric key pair of the first subsequent hardware module 204-A (ComponentID_HM1).

### Third Solution and Fourth Solution (Global Supplying Effect of Wrong UMS+SD)

In the example embodiment of the first solution illustrated in FIG. 3 and described above, a replaced subsequent hardware module will not receive the correct credentials and identities due to the UMS being different. However, no other hardware modules will be affected. This is not always a desired behavior, and in some embodiments, all hardware modules initialized after a misbehaving hardware component will also receive the wrong identity and credentials. This can be solved by using one of the following two alternatives.

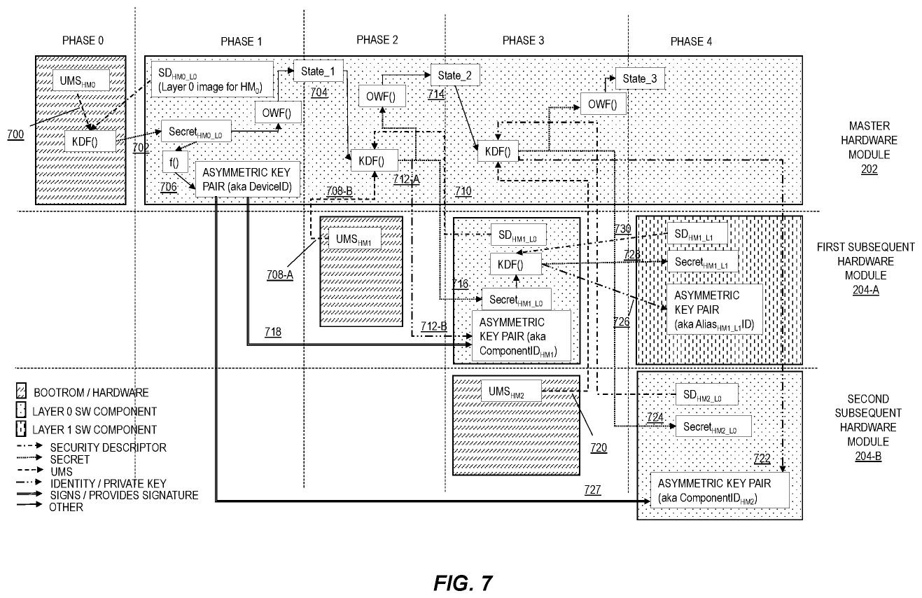

FIG. 7 illustrates one example embodiment of the third solution proposed in the present disclosure. Here, the master hardware module 202 retains a state after the first subsequent hardware module 204-A triggers a derivation of a secret and an identity of the first subsequent hardware module 204-A. A hardware module with the wrong UMS, therefore, causes all hardware modules yet-to-be-booted to receive the wrong secret and the identity. This embodiment requires deterministic boot order.

In step 700, the master hardware module 202 generates an UMS 206 of the master hardware module 202 (UMS_HM0). Optionally, the master hardware module 202 generates the UMS 206 of the master hardware module 202 by activating at least one PUF circuitry and reading data from at least one output from the PUF circuitry. Optionally, the master hardware module 202 generates the UMS 206 of the master hardware module 202 by reading data stored in a non-volatile memory. Optionally, the master hardware module 202 performs post-processing the data using one or more of a) one-way transformation and b) error-correcting circuitry.

In step 702, the master hardware module 202 derives a secret of the master hardware module 202 (secret_HM0) based on the UMS 206 of the master hardware module 202 (UMS_HM0) and a SD of the master hardware module 202 (SD_HM0_L0) using a first KDF of the master hardware module 202.

In step 704, the master hardware module 202 derives a first state (state_1). For example, the master hardware module 202 derives a first state (state_1) by utilizing an OWF, which takes, as an input, at least a previous state and at least one of: (a) a secret of a last hardware module booted, (b) a SD of the last hardware module booted, and (c) a UMS of the last hardware module booted.

In step 706, the master hardware module 202 generates an asymmetric key pair of the master hardware module 202 (DeviceID) based on the secret of the master hardware module 202 (secret_HM0) using a function. For example, the function is a probabilistic algorithm to derive an asymmetric key pair from a symmetric seed. Alternatively, this derivation may be performed within the KDF.

In steps 708-B and 710, the master hardware module 202 receives an UMS of the first subsequent hardware module 204-A (UMS_HM1) and a first SD of the first subsequent hardware module 204-A (SD_HM1_L0) from the first subsequent hardware module 204-A.

In step 712-A, the master hardware module 202 generates a first asymmetric key pair of the first subsequent hardware module 204-A (ComponentID_HM1) and a first secret for the first subsequent hardware module 204-A (secret_HM1_L0) based on the first state (state_1), the UMS of the first subsequent hardware module 204-A, and the first SD of the first subsequent hardware module 204-A (SD_HM1_L0) using a second KDF of the master hardware module 202. The second KDF may either be equal to the first KDF or a different KDF.

In step 714, the master hardware module 202 derives a second state (state_2). For example, the master hardware module 202 derives a second state (state_2) by utilizing an OWF, which takes, as an input, at least a previous state and at least one of: (a) a secret of a last hardware module booted, (b) a SD of the last hardware module booted, and (c) a UMS of the last hardware module booted.

In steps 712-B and 716, the master hardware module 202 provides the first asymmetric key pair of the first subsequent hardware module 204-A (ComponentID_HM1) and the first secret for the first subsequent hardware module 204-A (secret_HM1_L0) to the first subsequent hardware module 204-A.

In step 718, the master hardware module 202 signs a public key in the first asymmetric key pair of the first subsequent hardware module 204-A (ComponentID_HM1) with the asymmetric key pair of the master hardware module 202 (DeviceID).

In step 720, the master hardware module 202 receives an UMS of the second subsequent hardware module 204-B (UMS_HM2) and a first SD of the second subsequent hardware module 204-B (SD_HM2_L0) from the second subsequent hardware module (204-B). The UMS of the second subsequent hardware module (204-B) is generated by the second subsequent hardware module (204-B).

In steps 722 and 724, the master hardware module 202 generates a first asymmetric key pair of the second subsequent hardware module 204-B (ComponentID_HM2) and a first secret for the second subsequent hardware module 204-B (secret_HM2_L0) based on the second state (state_2), the UMS of the second subsequent hardware module 204-B, and the first SD of the second subsequent hardware module 204-B (SD_HM2_L0) using a second KDF of the master hardware module 202. The second KDF may either be equal to the first KDF or a different KDF.

In step 726, the master hardware module 202 signs a public key in the first asymmetric key pair of the second subsequent hardware module 204-B (ComponentID_HM2) with the asymmetric key pair of the master hardware module 202 (DeviceID).

In steps 708-A and 708-B, the first subsequent hardware module (204-A) generates the UMS of the first subsequent hardware module 204-A (UMS_HM1) and provides the UMS of the first subsequent hardware module 204-A (UMS_HM1) to the master hardware module 202, via an interface.

In steps 710 and 716, the first subsequent hardware module 204-A receives the first secret of the first subsequent hardware module 204-A (secret_HM1_L0) from the master hardware module 202 after providing the first SD of the first subsequent hardware module 204-A (SD_HM1_L0) to the master hardware module 202.

In steps 727, 728, and 730, the first subsequent hardware module 204-A generates a second asymmetric key pair of the first subsequent hardware module 204-A (Alias_HM1_L1_ID) and a second secret of the first subsequent hardware module 204-A (secret_HM1_L1) based on the second SD of the first subsequent hardware module 204-A (SD_HM1_L1) and a first secret for the first subsequent hardware module (secret_HM1_L0) using a KDF of the first subsequent hardware module 204-A.

As illustrated in FIG. 7, the KDF 210 is stateful and the output from the KDF 210 (or a derivative thereof) is fed back as an input to the KDF 210 during the next generation. The initial state, State_1, is derived from Secret_{HM0_L0} Using an OWF, i.e., State₁=OWF(Secret). The secret for the first subsequent hardware module 204-A is derived as Secret_{HM1_L0}=KDF(State₁, UMS_{HM1}, SD_{HM1_L0}), which is then used to update the master hardware module's 202 state as State2=OWF(Secret_{HM1_L0}).

For a potential third hardware module (e.g., the second subsequent hardware module 204-B), the following updates are made: Secret_{HM2_L0}=KDF(State₂, UMS_{HM2}, SD_{HM2_L0}), State₃=OWF(Secret_{HM2_L0}). This creates a situation where the identity of each hardware module is affected by the previous hardware module(s).

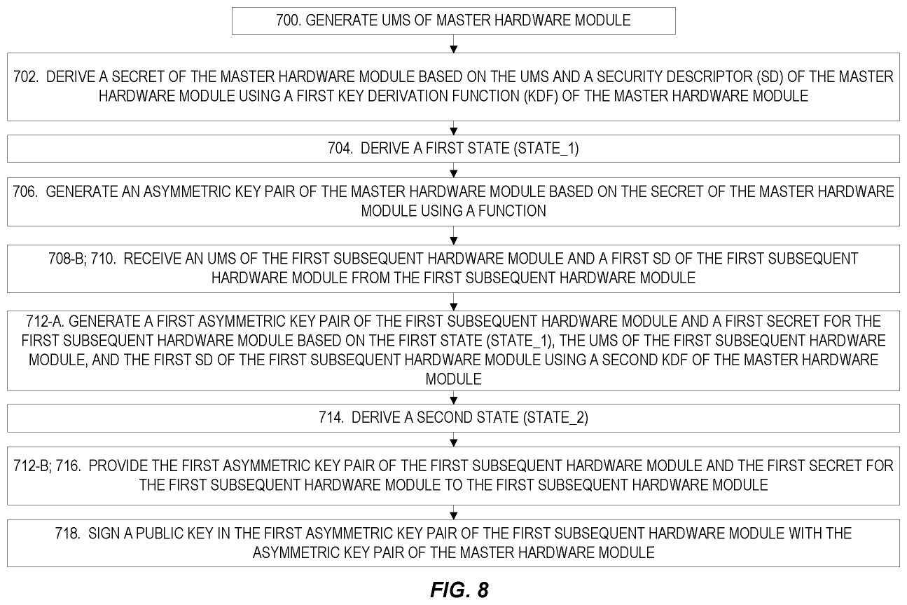

FIG. 8 illustrates a flow chart on the above-described example embodiment of the third solution proposed in the present application.

In step 700, the master hardware module 202 generates an UMS 206 of the master hardware module 202 (UMS_HM0). Optionally, the master hardware module 202 generates the UMS 206 of the master hardware module 202 by activating at least one PUF circuitry and reading data from at least one output from the PUF circuitry. Optionally, the master hardware module 202 generates the UMS 206 of the master hardware module 202 by reading data stored in a non-volatile memory. Optionally, the master hardware module 202 performs post-processing the data using one or more of a) one-way transformation and b) error-correcting circuitry.

In step 702, the master hardware module 202 derives a secret of the master hardware module 202 (secret_HM0) based on the UMS 206 of the master hardware module 202 (UMS_HM0) and a SD of the master hardware module 202 (SD_HM0_L0) using a first KDF of the master hardware module 202.

In step 704, the master hardware module 202 derives a first state (state_1). For example, the master hardware module 202 derives a first state (state_1) by utilizing an OWF, which takes, as an input, at least a previous state and at least one of: (a) a secret of a last hardware module booted, (b) a SD of the last hardware module booted, and (c) a UMS of the last hardware module booted.

In step 706, the master hardware module 202 generates an asymmetric key pair of the master hardware module 202 (DeviceID) based on the secret of the master hardware module 202 (secret_HM0) using a function. For example, the function is a probabilistic algorithm to derive an asymmetric key pair from a symmetric seed.

In steps 708-B and 710, the master hardware module 202 receives an UMS of the first subsequent hardware module 204-A (UMS_HM1) and a first SD of the first subsequent hardware module 204-A (SD_HM1_L0) from the first subsequent hardware module 204-A.

In step 712-A, the master hardware module 202 generates a first asymmetric key pair of the first subsequent hardware module 204-A (ComponentID_HM1) and a first secret for the first subsequent hardware module 204-A (secret_HM1_L0) based on the first state (state_1), the UMS of the first subsequent hardware module 204-A, and the first SD of the first subsequent hardware module 204-A (SD_HM1_L0) using a second KDF of the master hardware module 202. The second KDF may either be equal to the first KDF or a different KDF.

In step 714, the master hardware module 202 derives a second state (state_2). For example, the master hardware module 202 derives a second state (state_2) by utilizing an OWF, which takes, as an input, at least a previous state and at least one of: (a) a secret of a last hardware module booted, (b) a SD of the last hardware module booted, and (c) a UMS of the last hardware module booted.

In steps 712-B and 716, the master hardware module 202 provides the first asymmetric key pair of the first subsequent hardware module 204-A (ComponentID_HM1) and the first secret for the first subsequent hardware module 204-A (secret_HM1_L0) to the first subsequent hardware module 204-A.

In step 718, the master hardware module 202 signs a public key in the first asymmetric key pair of the first subsequent hardware module 204-A (ComponentID_HM1) with the asymmetric key pair of the master hardware module 202 (DeviceID).

The master hardware module 202 may further perform the following optional steps illustrated in FIG. 7.

In step 720, the master hardware module 202 receives an UMS of the second subsequent hardware module 204-B (UMS_HM2) and a first SD of the second subsequent hardware module 204-B (SD_HM2_L0) from the second subsequent hardware module (204-B). The UMS of the second subsequent hardware module (204-B) is generated by the second subsequent hardware module (204-B).

In steps 722 and 724, the master hardware module 202 generates a first asymmetric key pair of the second subsequent hardware module 204-B (ComponentID_HM2) and a first secret for the second subsequent hardware module 204-B (secret_HM2_L0) based on the second state (state_2), the UMS of the second subsequent hardware module 204-B, and the first SD of the second subsequent hardware module 204-B (SD_HM2_L0) using a second KDF of the master hardware module 202. The second KDF may either be equal to the first KDF or a different KDF.

In step 726, the master hardware module 202 signs a public key in the first asymmetric key pair of the second subsequent hardware module 204-B (ComponentID_HM2) with the asymmetric key pair of the master hardware module 202 (DeviceID).

As illustrated in FIG. 7, the first subsequent hardware module 204-a may

perform the following steps.

In steps 708-A and 708-B, the first subsequent hardware module (204-A) generates the UMS of the first subsequent hardware module 204-A (UMS_HM1) and provides the UMS of the first subsequent hardware module 204-A (UMS_HM1) to the master hardware module 202, via an interface.

In steps 710 and 716, the first subsequent hardware module 204-A receives the first secret of the first subsequent hardware module 204-A (secret_HM1_L0) from the master hardware module 202 after providing the first SD of the first subsequent hardware module 204-A (SD_HM1_L0) to the master hardware module 202.

In steps 727, 728, and 730, the first subsequent hardware module 204-A generates a second asymmetric key pair of the first subsequent hardware module 204-A (Alias_HM1_L1_ID) and a second secret of the first subsequent hardware module 204-A (secret_HM1_L1) based on a first secret for the first subsequent hardware module (secret_HM1_L0)) and a second SD of the first subsequent hardware module 204-A (SD_HM1_L1) using a KDF of the first subsequent hardware module 204-A. The private key in the first asymmetric key pair of the first subsequent hardware module may additionally be used to sign a public key in the second asymmetric key pair of the first subsequent hardware module.

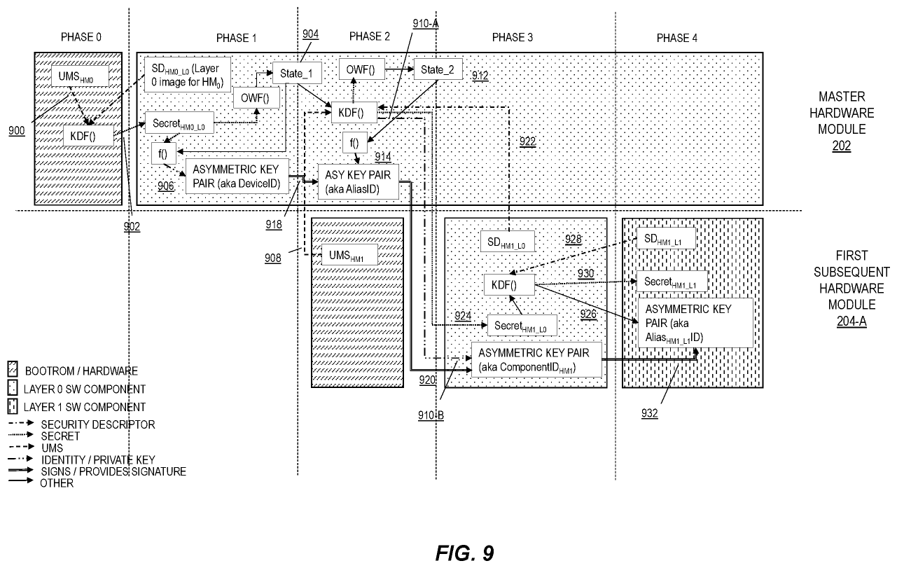

FIG. 9 illustrates an example embodiment of the fourth solution. Here, the identity of the master hardware module 202 is updated after the first subsequent hardware module 204-A triggers a derivation of a secret and an identity of the first subsequent hardware module 204-A. Just as in the third solution illustrated in FIG. 7, a hardware module with the wrong UMS therefore causes all hardware modules yet-to-be-booted to receive the wrong secret and identity. In addition, the master hardware module 202 also receives the wrong secret and identity. This solution requires deterministic boot order.

In step 900, the master hardware module 202 generates an UMS 206 of the master hardware module 202 (UMS_HM0). Optionally, the master hardware module 202 generates the UMS 206 of the master hardware module 202 by activating at least one PUF circuitry and reading data from at least one output from the PUF circuitry. Optionally, the master hardware module 202 generates the UMS 206 of the master hardware module 202 by reading data stored in a non-volatile memory. Optionally, the master hardware module 202 performs post-processing the data using one or more of a) one-way transformation and b) error-correcting circuitry.

In step 902, the master hardware module 202 derives a secret of the master hardware module 202 (secret_HM0) based on the UMS (UMS_HM0) and a SD of the master hardware module 202 (SD_HM0_L0) using a first KDF of the master hardware module 202.

In step 904, the master hardware module 202 derives a first state (state_1). For example, the master hardware module 202 derives a first state (state_1) by utilizing an OWF, which takes, as an input, at least a previous state and at least one of: (a) a secret of a last hardware module booted, (b) a SD of the last hardware module booted, and (c) a UMS of the last hardware module booted.

In step 906, the master hardware module 202 generates a first asymmetric key pair of the master hardware module 202 (DeviceID) based on the secret of the master hardware module 202 (secret_HM0) and the first state (state_1) using a first function. For example, the first function is a probabilistic algorithm to derive an asymmetric key pair from a symmetric seed.

In step 908, the master hardware module 202 receives an UMS of the first subsequent hardware module 204-A (UMS_HM1) and a first SD of the first subsequent hardware module 204-A (SD_HM1_L0) from the first subsequent hardware module 204-A.

In step 910-A, the master hardware module 202 generates a first asymmetric key pair of the first subsequent hardware module 204-A (ComponentID_HM1) and a first secret for the first subsequent hardware module 204-A (secret_HM1_L0) based on the first state (state_1), the UMS of the first subsequent hardware module 204-A and the first SD of the first subsequent hardware module 204-A (SD_HM1_L0) using a second KDF of the master hardware module 202. The second KDF may either be equal to the first KDF or a different KDF.

In step 912, the master hardware module 202 derives a second state (state_2). For example, the master hardware module 202 derives a second state (state_2) by utilizing an OWF, which takes, as an input, at least a previous state and at least one of: (a) a secret of a last hardware module booted, (b) a SD of the last hardware module booted, and (c) a UMS of the last hardware module booted.

In step 914, the master hardware module 202 generates a second asymmetric key pair (AliasID) based on the second state (slate_2) using a second function. For example, the second function is a probabilistic algorithm to derive an asymmetric key pair from a symmetric seed.

In step 916-B, the master hardware module 202 provides the first asymmetric key pair of the first subsequent hardware module 204-A (ComponentID_HM1) and the first secret for the first subsequent hardware module 204-A (secret_HM1_L0) to the first subsequent hardware module 204-A.

In steps 918 and 920, the master hardware module 202 signs a public key in the second asymmetric key pair (AliasID) with the asymmetric key pair of the master hardware module 202 (DeviceID) and signs a public key in the first asymmetric key pair of the first subsequent hardware module 204-A (ComponentID_HM1) with the second asymmetric key pair (AliasID).

In steps 922 and 924, the first subsequent hardware module 204-A receives the first secret of the first subsequent hardware module 204-A (secret_HM1_L0) from the master hardware module after providing the first SD of the first subsequent hardware module 204-A (SD_HM1_L0) to the master hardware module 202.

In steps 926 and 928, the first subsequent hardware module 204-A generates an asymmetric key pair of the first subsequent hardware module 204-A (Alias_HM1_L1_ID) and a second secret of the first subsequent hardware module 204-A (secret_HM1_L1) based on a second SD of the first subsequent hardware module 204-A (SD_HM1_L1) and a first secret for the first subsequent hardware module (secret_HM1_L0) using a KDF of the first subsequent hardware module 204-A.

In step 932, the first subsequent hardware module 204-A signs a public key in the second asymmetric key pair of the first subsequent hardware module 204-A (Alias_HM1_L1_ID) with the first asymmetric key pair of the first subsequent hardware module 204-A (ComponentID_HM1).

In one embodiment of the fourth solution, when a state is updated, the secret and the identity of the master hardware module 202 is also updated, hence being affected by the other hardware modules. The new AliasID is signed or certified (certificate issued) by the old AliasID before deleting the private key of the DeviceID. Any further invocations of the KDF results in AliasID2, AliasID3 etc., each deleting the private key of the previous AliasID. Note that the full certificate chain needs to be stored to maintain a verifiable chain of trust. Hence, whenever the KDF is invoked, the identity of the master hardware module 202 is updated.

In one embodiment of the fourth solution, the new AliasID of the master hardware module is used to sign the private key of the first subsequent hardware module 204-A, in another variant, it is signed by the old AliasID.

In one embodiment of the fourth solution (not depicted), the secret of the master hardware module may be updated for each invocation of the KDF. The current secret +the current state would be used as input to a KDF/OWF to create a new secret for master hardware module. The newly generated secret would in turn be used to create a new identity.

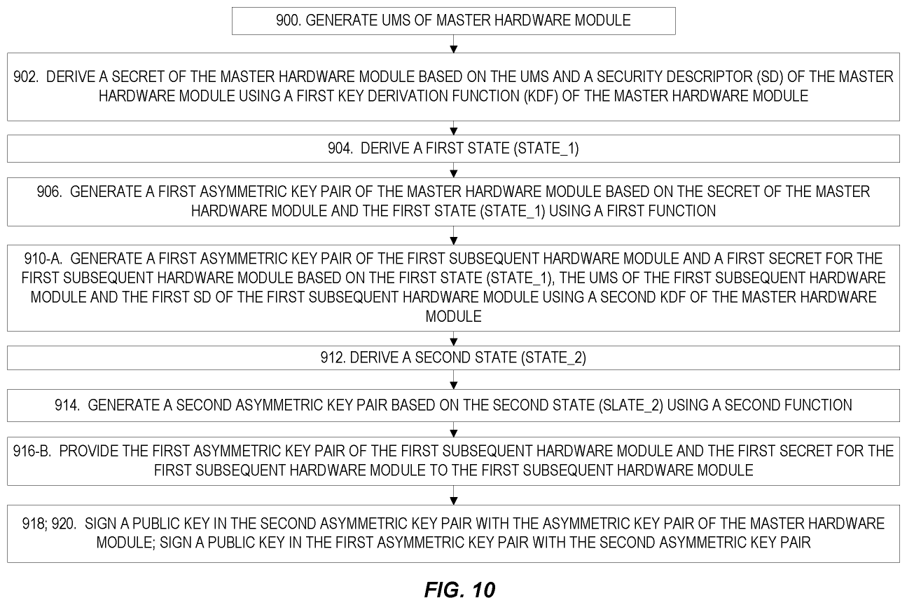

FIG. 10 illustrates a flow chart on the above-described fourth solution proposed in the present application and illustrated in FIG. 9.

In step 900, the master hardware module 202 generates an UMS 206 of the master hardware module 202 (UMS_HM0). Optionally, the master hardware module 202 generates the UMS 206 of the master hardware module 202 by activating at least one PUF circuitry and reading data from at least one output from the PUF circuitry. Optionally, the master hardware module 202 generates the UMS 206 of the master hardware module 202 by reading data stored in a non-volatile memory. Optionally, the master hardware module 202 performs post-processing the data using one or more of a) one-way transformation and b) error-correcting circuitry.

In step 902, the master hardware module 202 derives a secret of the master hardware module 202 (secret_HM0) based on the UMS (UMS_HM0) and a SD of the master hardware module 202 (SD_HM0_L0) using a first KDF of the master hardware module 202.

In step 904, the master hardware module 202 derives a first state (state_1). For example, the master hardware module 202 derives a first state (state_1) by utilizing an OWF, which takes, as an input, at least a previous state and at least one of: (a) a secret of a last hardware module booted, (b) a SD of the last hardware module booted, and (c) a UMS of the last hardware module booted.

In step 906, the master hardware module 202 generates a first asymmetric key pair of the master hardware module 202 (DeviceID) based on the secret of the master hardware module 202 (secret_HM0) and the first state (state_1) using a first function. For example, the first function is a probabilistic algorithm to derive an asymmetric key pair from a symmetric seed. Alternatively, this derivation may be performed within the KDF.

In step 908, the master hardware module 202 receives an UMS of the first subsequent hardware module 204-A (UMS_HM1) and a first SD of the first subsequent hardware module 204-A (SD_HM1_L0) from the first subsequent hardware module 204-A.

In step 910-A, the master hardware module 202 generates a first asymmetric key pair of the first subsequent hardware module 204-A (ComponentID_HM1) and a first secret for the first subsequent hardware module 204-A (secret_HM1_L0) based on the first state (state_1), the UMS of the first subsequent hardware module 204-A and the first SD of the first subsequent hardware module 204-A (SD_HM1_L0) using a second KDF of the master hardware module 202. The second KDF may either be equal to the first KDF or a different KDF.

In step 912, the master hardware module 202 derives a second state (state_2). For example, the master hardware module 202 derives a second state (state_2) by utilizing an OWF, which takes, as an input, at least a previous state and at least one of: (a) a secret of a last hardware module booted, (b) a SD of the last hardware module booted, and (c) a UMS of the last hardware module booted.

In step 914, the master hardware module 202 generates a second asymmetric key pair (AliasID) based on the second state (state_2) using a second function. For example, the second function is a probabilistic algorithm to derive an asymmetric key pair from a symmetric seed.

In step 916-B, the master hardware module 202 provides the first asymmetric key pair of the first subsequent hardware module 204-A (ComponentID_HM1) and the first secret for the first subsequent hardware module 204-A (secret_HM1_L0) to the first subsequent hardware module 204-A.

In steps 918 and 920, the master hardware module 202 signs a public key in the second asymmetric key pair (AliasID) with the asymmetric key pair of the master hardware module 202 (DeviceID) and signs a public key in the first asymmetric key pair of the first subsequent hardware module 204-A (ComponentID_HM1) with the second asymmetric key pair (AliasID).

As illustrated in FIG. 9, the first subsequent hardware module 204-A may perform the following optional steps.

In steps 922 and 924, the first subsequent hardware module 204-A receives the first secret of the first subsequent hardware module 204-A (secret_HM1_L0) from the master hardware module after providing the first SD of the first subsequent hardware module 204-A (SD_HM1_L0) to the master hardware module 202.

In steps 926 and 928, the first subsequent hardware module 204-A generates an asymmetric key pair of the first subsequent hardware module 204-A (Alias_HM1_L1_ID) and a second secret of the first subsequent hardware module 204-A (secret_HM1_L1) based on a second SD of the first subsequent hardware module 204-A (SD_HM1_L1) and a first secret for the first subsequent hardware module (secret_HM1_L0) using a KDF of the first subsequent hardware module 204-A.

In step 932, the first subsequent hardware module 204-A signs a public key in the second asymmetric key pair of the first subsequent hardware module 204-A (Alias_HM1_L1_ID) with the first asymmetric key pair of the first subsequent hardware module 204-A (ComponentID_HM1).

### Other Solutions (UMS Implementation Alternatives)

In the first solution, the PUF is used to generate the UMS 206 for each hardware component (e.g., hardware components 208). However, other alternatives are also possible, e.g., an identity programmed in the NVM 214 such as OTP.

Alternatively or additionally, the UMS 206 may be generated using an OWF, MAC, PRNG or KDF, which utilizes an input from the PUF, or a value programmed in the NVM 214 to generate the UMS 206.

### Other Solutions (UMS dependent on Input and/or Hardware Status)

In one embodiment of other solutions, the UMS 206 is not only dependent on the identity of the master hardware module but also the current state of the master hardware module. The state of the master hardware module may be derived from internal measurements of the master hardware module. Such measurements may comprise sensors 216 (e.g., measuring heat, voltage, electromagnetic radiation), results from self-attestation and configuration options (such as fused options, initial PIN values etc.) that may be acquired from the self-test circuitry 218. In one embodiment, this also applies to the subsequent hardware modules 204 and their respective UMS 220, Sensors 226 and Self-Test Circuitry 228.

These values can be used to create the UMS 206, where sensor values can be compared with certain fixed thresholds and output binary indications of the result. An example output can take the form of:

$$UMS = OWF ( PUF response ‖ Temperature below 50 C . ‖ Voltage above 2 , 8 V and below 4 V ) .$$

In one embodiment of other solutions, the PUF, which generates the UMS 220 in each of the subsequent hardware modules 204-A, receives a challenge, which may be hard-coded internally in the hardware module or be supplied from the master hardware module 202. This challenge is supplied to the PUF and the PUF creates a response correlated to the challenge. If the challenge is supplied from the master hardware module 202, it may serve as an effective way of updating all hardware modules with a new UMS, and thereby new credentials and identities. In one embodiment, the PUF which generates the UMS 206 may also receive a challenge as described above.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
ASIC Application Specific Integrated Circuit
BBRAM Battery Backed Random Access Memory
BIOS Basic Input/Output System
BIST Built-In Self-Test
BS Bitstream
CA Certificate Authority
COTS Commercial off-the-shelf
CPU Central Processing Unit
DICE Device Identifier Composition Engine
DSP Digital Signal Processor
FIB Focused Ion Beam
FPGA Field Programmable Gate Array
FW Firmware
GPU Graphic Processing Unit
HW Hardware
I/O Input/Output
JTAG Joint Test Action Group
KDF Key Derivation Function
KEK Key Encryption Key
MAC Message Authentication Code
MP MicroProcessor
NVM Non-Volatile Memory
OTP One Time Programmable
OWF One Way Function
PCIE Peripheral Component Interconnect Express
PCR Platform Configuration Registers
PRNG Pseudorandom number generator
PUF Physically Unclonable Function
RAM Random Access Memory
ROM Read Only Memory
RoT Root-of-Trust
SATA Serial Advanced Technology Attachment
SD Security Descriptor
SPI Serial Peripheral Interface
SRAM Static Random Access Memory
SW Software
TCG Trusted Computing Group
TEE Trusted Execution Environment
TPM Trusted Platform Module
UART Universal Asynchronous Receiver-Transmitter
UDS Unique Device Secret
UMS Unique Module Secret
USB Universal Serial Bus

Those skilled in the art will recognize improvements and modifications to the embodiments of the present disclosure. All such improvements and modifications are considered within the scope of the concepts disclosed herein.

1. A method performed by a master hardware module in a device comprising the master hardware module and at least a first subsequent hardware module, comprising:
generating a Unique Module Secret, UMS, of the master hardware module (UMS_HM0);
deriving a secret of the master hardware module (secret_HM0) based on the UMS of the master hardware module (UMS_HM0) and a Security Descriptor, SD, of the master hardware module (SD_HM0_L0) using a first Key Derivation Function, KDF, of the master hardware module;
generating an asymmetric key pair of the master hardware module (DeviceID) based on the secret of the master hardware module (secret_HM0) using a function (f( )); and
receiving a UMS of the first subsequent hardware module (UMS_HM1) and a first SD of the first subsequent hardware module (SD_HM1_L0) from the first subsequent hardware module

2. The method of claim 1, wherein generating the UMS of the master hardware module (UMS_HM0) comprises generating the UMS of the master hardware module by activating at least one Physically Unclonable Function, PUF, circuitry and reading data from at least one output from the PUF circuitry.

3. The method of claim 1, wherein generating the UMS of the master hardware module (UMS_HM0) comprises generating the UMS of the master hardware module by reading data stored in a non-volatile memory.

4. The method of claim 2, wherein generating the UMS of the master hardware module (UMS_HM0) further comprises post-processing the data using one or more of a) one-way transformation and b) error-correcting circuitry.

5. The method of claim 1, wherein:
the first subsequent hardware module (HM1) generates and provides the UMS of the first subsequent hardware module (HM1) (UMS_HM1) to the master hardware module (HM0) via an interface;
the first subsequent hardware module receives the first secret of the first subsequent hardware module (secret_HM1_L0) from the master hardware module after providing the first SD of the first subsequent hardware module (SD_HM1_L0) to the master hardware module;
the first subsequent hardware module generates a first asymmetric key pair of the first subsequent hardware module (ComponentID_HM1) based on the first secret of the first subsequent hardware module (secret_HM1_L0) using a function of the first subsequent hardware module;
the first subsequent hardware module generates a second asymmetric key pair of the first subsequent hardware module (Alias_HM1_L1_ID) and a second secret of the first subsequent hardware module (secret_HM1_L1) based on a second SD of the first subsequent hardware module (SD_HM1_L1) and the first secret for the first subsequent hardware module (secret_HM1_L0) using a KDF of the first subsequent hardware module; and
the first subsequent hardware module signs a public key in the second asymmetric key pair of the first subsequent hardware module (Alias_HM1_L1_ID) with the first asymmetric key pair of the first subsequent hardware module (ComponentID_HM1).

6. The method of claim 1, further comprising:
generating a first asymmetric key pair of the first subsequent hardware module (ComponentID_HM1) based on the secret of the master hardware module (secret_HM0), the UMS of the first subsequent hardware module and the first SD of the first subsequent hardware module (SD_HM1_L0) using the second KDF of the master hardware module;
providing the first asymmetric key pair of the first subsequent hardware module (ComponentID_HM1) to the first subsequent hardware module; and
signing a public key in the first asymmetric key pair of the first subsequent hardware module (ComponentID_HM1) with the asymmetric key pair of the master hardware module (DeviceID).

7. The method of claim 6, wherein:
the first subsequent hardware module receives the first secret of the first subsequent hardware module (secret_HM1_L0) from the master hardware module after providing the first SD of the first subsequent hardware module (SD_HM1_L0) to the master hardware module;
the first subsequent hardware module generates (318; 316; 313) a second asymmetric key pair of the first subsequent hardware module (Alias_HM1_L1_ID) and a second secret of the first subsequent hardware module (HM1) (secret_HM1_L1) based on a second SD of the first subsequent hardware module (SD_HM1_L1) and first secret of the first subsequent hardware module (secret_HM1_L0) using a KDF of the first subsequent hardware module (HM1); and
the first subsequent hardware module signs a public key in the second asymmetric key pair of the first subsequent hardware module (Alias_HM1_L1_ID) with the first private key of the first subsequent hardware module (ComponentID_HM1).

8. The method of claim 1, further comprising:
determining whether there is a second subsequent hardware module;
when it is determined that there is the second subsequent hardware module,
receiving a UMS of the second subsequent hardware module (UMS_HM2) and a first SD of the second subsequent hardware module (SD_HM2_L0) from the second subsequent hardware module, the UMS of the second subsequent hardware module being generated by the second subsequent hardware module B);
generating a first secret for 204-B (secret_HM2_L0) based on the secret of the master hardware module (secret_HM0), the UMS of the second subsequent hardware module and the first SD of the second subsequent hardware module (SD_HM2_L0) using a second KDF of the master hardware module; and
providing the first secret for the second subsequent hardware module (secret_HM2_L0) to the second subsequent hardware module.

9. The method of claim 1, wherein the function (f( )) is a probabilistic algorithm to derive an asymmetric key pair from a symmetric seed.

10-26. (canceled)

27. A master hardware module in a device comprising the master hardware module and at least a first subsequent hardware module, comprising:
processing circuitry and memory collectively configured to perform operations comprising:
generating a Unique Module Secret, UMS, of the master hardware module (UMS_HM0);
deriving a secret of the master hardware module (secret_HM0) based on the UMS of the master hardware module (UMS_HM0) and a Security Descriptor, SD, of the master hardware module (SD_HM0_L0) using a first Key Derivation Function, KDF, of the master hardware module;
generating an asymmetric key pair of the master hardware module (DeviceID) based on the secret of the master hardware module (secret_HM0) using a function (f( )); and
receiving a UMS of the first subsequent hardware module (UMS_HM1) and a first SD of the first subsequent hardware module (SD_HM1_L0) from the first subsequent hardware module.

28-32. (canceled)

33. The master hardware module of claim 27, wherein generating the UMS of the master hardware module (UMS_HM0) comprises generating the UMS of the master hardware module by activating at least one Physically Unclonable Function, PUF, circuitry and reading data from at least one output from the PUF circuitry.

34. The master hardware module of claim 27, wherein generating the UMS of the master hardware module (UMS_HM0) comprises generating the UMS of the master hardware module by reading data stored in a non-volatile memory.

35. The master hardware module of claim 33, wherein generating the UMS of the master hardware module (UMS_HM0) further comprises post-processing the data using one or more of a) one-way transformation and b) error-correcting circuitry.

36. The master hardware module of claim 27, wherein:
the first subsequent hardware module (HM1) generates and provides the UMS of the first subsequent hardware module (HM1) (UMS_HM1) to the master hardware module (HM0) via an interface;
the first subsequent hardware module receives the first secret of the first subsequent hardware module (secret_HM1_L0) from the master hardware module after providing the first SD of the first subsequent hardware module (SD_HM1_L0) to the master hardware module;
the first subsequent hardware module generates a first asymmetric key pair of the first subsequent hardware module (ComponentID_HM1) based on the first secret of the first subsequent hardware module (secret_HM1_L0) using a function of the first subsequent hardware module;
the first subsequent hardware module generates a second asymmetric key pair of the first subsequent hardware module (Alias_HM1_L1_ID) and a second secret of the first subsequent hardware module (secret_HM1_L1) based on a second SD of the first subsequent hardware module (SD_HM1_L1) and the first secret for the first subsequent hardware module (secret_HM1_L0) using a KDF of the first subsequent hardware module; and
the first subsequent hardware module signs a public key in the second asymmetric key pair of the first subsequent hardware module (Alias_HM1_L1_ID) with the first asymmetric key pair of the first subsequent hardware module (ComponentID_HM1).

37. The master hardware module of claim 27, wherein the operations further comprise:
generating a first asymmetric key pair of the first subsequent hardware module (ComponentID_HM1) based on the secret of the master hardware module (secret_HM0), the UMS of the first subsequent hardware module, and the first SD of the first subsequent hardware module (SD_HM1_L0) using the second KDF of the master hardware module;
providing the first asymmetric key pair of the first subsequent hardware module (ComponentID_HM1) to the first subsequent hardware module; and
signing a public key in the first asymmetric key pair of the first subsequent hardware module (ComponentID_HM1) with the asymmetric key pair of the master hardware module (DeviceID).

38. The master hardware module of claim 37, wherein:
the first subsequent hardware module receives the first secret of the first subsequent hardware module (secret_HM1_L0) from the master hardware module after providing the first SD of the first subsequent hardware module (SD_HM1_L0) to the master hardware module;
the first subsequent hardware module generates a second asymmetric key pair of the first subsequent hardware module (Alias_HM1_L1_ID) and a second secret of the first subsequent hardware module (HM1) (secret_HM1_L1) based on a second SD of the first subsequent hardware module (SD_HM1_L1) and first secret of the first subsequent hardware module (secret_HM1_L0) using a KDF of the first subsequent hardware module (HM1); and
the first subsequent hardware module signs a public key in the second asymmetric key pair of the first subsequent hardware module (Alias_HM1_L1_ID) with the first private key of the first subsequent hardware module (ComponentID_HM1).

39. The master hardware module of claim 27, wherein the operations further comprise:
determining whether there is a second subsequent hardware module;
when it is determined that there is the second subsequent hardware module,
receiving a UMS of the second subsequent hardware module (UMS_HM2) and a first SD of the second subsequent hardware module (SD_HM2_L0) from the second subsequent hardware module, the UMS of the second subsequent hardware module being generated by the second subsequent hardware module;
generating a first secret for 204-B (secret_HM2_L0) based on the secret of the master hardware module (secret_HM0), the UMS of the second subsequent hardware module, and the first SD of the second subsequent hardware module (SD_HM2_L0) using a second KDF of the master hardware module; and
providing the first secret for the second subsequent hardware module (secret_HM2_L0) to the second subsequent hardware module.

40. The master hardware module of claim 27, wherein the function (f( )) is a probabilistic algorithm to derive an asymmetric key pair from a symmetric seed.
